(19) United States
(12) Patent Application Publication
(10) Pub. No.: US 2026/0344647 A1
(43) Pub. Date: Nov. 5, 2026

(54) Insect Repeller Device

(71) Applicant: Thermacell Repellents, Inc., Bedford, MA (US)

(72) Inventor: Robert Townsend, Somerville, MA (US)

(73) Assignee: Thermacell Repellents, Inc., Bedford, MA (US)

(21) Appl. No.: 19/487,215

(22) PCT Filed: May 23, 2024
(86) PCT No.: PCT/US2024/030716

§ 371 Date: Nov. 24, 2025

(51) Int. Cl. A01M 29/12; H05B 3/02

(52) U.S. Cl. CPC A01M 29/12; H05B 3/02

(57) ABSTRACT

An insect repeller includes a repeller housing defining a reservoir holder and having a chimney centrally formed therein. A heater assembly is disposed within the repeller housing assembly and includes a heater base attached to an underside of a heater housing. The heater housing has a cylindrical heater defining a heater bore, wherein the heater bore is in fluid communication with the chimney, wherein the heater is electrically connected to a source of electrical power, and wherein the heater base includes a conical heater funnel.

### CROSS-REFERENCE TO RELATED APPLICATIONS

This application claims the benefit of U.S. Provisional Application No. 63/468,683, filed May 24, 2023, the disclosure of which is incorporated herein by reference in its entirety.

### BACKGROUND OF THE INVENTION

This invention relates in general to insect repellers. In particular, this invention relates to an improved insect repeller structure that facilitates the reclamation of condensed repellent material, and mor efficiently directs air flow through the heater bore and wick to facilitate evaporation and delivery of repellent material through the chimney.

Outdoor spaces provide an attractive place for people to gather, eat, and relax. However, these spaces also attract insects and other pests which can hamper effective area utilization and, particularly in a commercial setting, create an undesirable environment which reduces profitability and can adversely impact a facility's reputation. Individual insect repellers are known and create defined areas of protection from pests. These devices work well but are independently operated and may not provide efficient utilization of volatized materials which increases costs. Other devices are known to be linked to provide power for heating elements but do not regulate operation of the devices in response to environmental conditions or system performance levels.

The ability to conveniently and effectively control an outdoor environment with respect to pest repelling or ambiance creation is hampered by the ability of insect repellers to communicate and coordinate operational status, adjust output parameters based on local conditions, and accommodate different materials and outputs to provide different environmental effects such as scent regulation, lighting control, and audio outputs. In addition, the outdoor environment provides deleterious conditions, such as rain, wind, and temperature changes that reduce the ability to efficiently use emissive materials and cause condensation to form on an upper surface of the insect repeller.

Further, known methods of repelling insects have included the direct application of chemical repellents on surfaces, and the ambient release of repellents through evaporative or combustion processes. However, these known methods often distribute repellent inefficiently, create potential safety hazards, require the inconvenience of manual operation, and are inefficient due to the loss of unspent repellent during operation.

Thus, it would be desirable to provide an improved insect repeller that facilitates the facilitates reclamation of condensed repellent material back towards the wick at the heater bore junction, and improves air flow through the heater bore and wick to facilitate evaporation and delivery of repellent material through the chimney.

### SUMMARY OF THE INVENTION

This invention relates to an improved insect repeller structure that facilitates the reclamation of condensed repellent material back towards the wick at the heater bore junction, and mor efficiently directs air flow through the heater bore and wick to facilitate evaporation and delivery of repellent material through the chimney.

In one embodiment, the insect repeller includes a repeller housing defining a reservoir holder and having a chimney centrally formed therein. A heater assembly is disposed within the repeller housing assembly and includes a heater base attached to an underside of a heater housing. The heater housing has a cylindrical heater defining a heater bore, wherein the heater bore is in fluid communication with the chimney, wherein the heater is electrically connected to a source of electrical power, and wherein the heater base includes a conical heater funnel.

In another embodiment, the insect repeller includes a repeller housing defining a reservoir holder and having a chimney centrally formed therein. The repeller housing includes a base, a cover assembly, and an intermediate portion between the base and the cover assembly that defines a beltline. When the cover assembly and the intermediate portion are attached together, they define a housing subassembly. The insect repeller further includes a user interface mounted in the cover assembly, the user interface having an on/off power button mounted within an integrated status indicator lens, wherein the status indicator lens includes optical identifier windows that signal states of operation and potential fault situations. A device PCB is mounted within the housing subassembly and has a microcontroller, an on/off power switch, and LEDs. A battery is electrically connected to the PCB, and a plurality of light pipes extend between the LEDs on the device PCB and an interior side of the optical identifier windows of the status indicator lens and direct light from the LEDs to the status indicator lens. A first end of each light pipe is flared and abuts the device PCB about one of the LEDs and a second end of each light pipe abuts the status indicator lens. The flared light pipes are resilient and are configured to act as a return spring to reposition the on/off power button after an insect repeller operator has pressed the on/off power button to engage the on/off power switch.

In an additional embodiment, the insect repeller includes a repeller housing defining a reservoir holder and having a chimney centrally formed on an upper end thereof. The repeller housing includes a base, a cover assembly, and an intermediate portion between the base and the cover assembly that defines a beltline. When the cover assembly and the intermediate portion are attached together, they define a housing subassembly. The insect repeller further includes a device PCB mounted within the housing subassembly and having a microcontroller and electronic components. A battery is electrically connected to the PCB and a bottle sensing switch is mounted within the subassembly. The bottle sensing switch is movable between an actuated position wherein the insect repeller is operational and an unactuated position wherein the insect repeller is prevented from operating. The bottle sensing switch is moved to the actuated position when the reservoir bottle is properly installed within the insect repeller, and the bottle sensing switch is moved to the unactuated position when the reservoir bottle is not installed, thus preventing operation of the insect repeller when the reservoir bottle is not installed.

Various aspects of this invention will become apparent to those skilled in the art from the following detailed description of the preferred embodiment, when read in view of the accompanying drawings.

### BRIEF DESCRIPTION OF THE DRAWINGS

FIG. 1A is a perspective view of an insect repeller in accordance with the invention.

FIG. 1B is a partially exploded perspective view of the insect repeller illustrated in FIG. 1A.

FIG. 2 is a perspective view of the insect repeller illustrated in FIGS. 1A and 1B showing the underside of the insect repeller.

FIG. 3 is a perspective view of the intermediate portion of the insect repeller illustrated in FIGS. 1A and 1B showing the beltline.

FIG. 4 is a cross-sectional view of the insect repeller taken along the line 4-4 of FIG. 1A and shown without the reservoir bottle.

FIG. 5 is a cross-sectional view of the insect repeller taken along the line 5-5 of FIG. 1A and shown without the reservoir bottle.

FIG. 6 is a perspective view of the heater assembly and the device PCB illustrated in FIG. 4.

FIG. 7A is a first perspective view of the heater base illustrated in FIGS. 4 and 5.

FIG. 7B is a second perspective view of the heater base illustrated in FIG. 7A showing the conical heater funnel.

FIG. 8 is a perspective view of a base of the insect repeller illustrated in FIGS. 1A, 1B, and 4.

FIG. 9 is a perspective view of a reservoir bottle configured for use in the insect repeller illustrated in FIGS. 1A and 1B.

FIG. 10 is a first enlarged cross-sectional view of the insect repeller illustrated in FIG. 5 with the reservoir bottle installed.

FIG. 11 is a second enlarged cross-sectional view of the insect repeller illustrated in FIG. 5 with the reservoir bottle installed.

### DETAILED DESCRIPTION

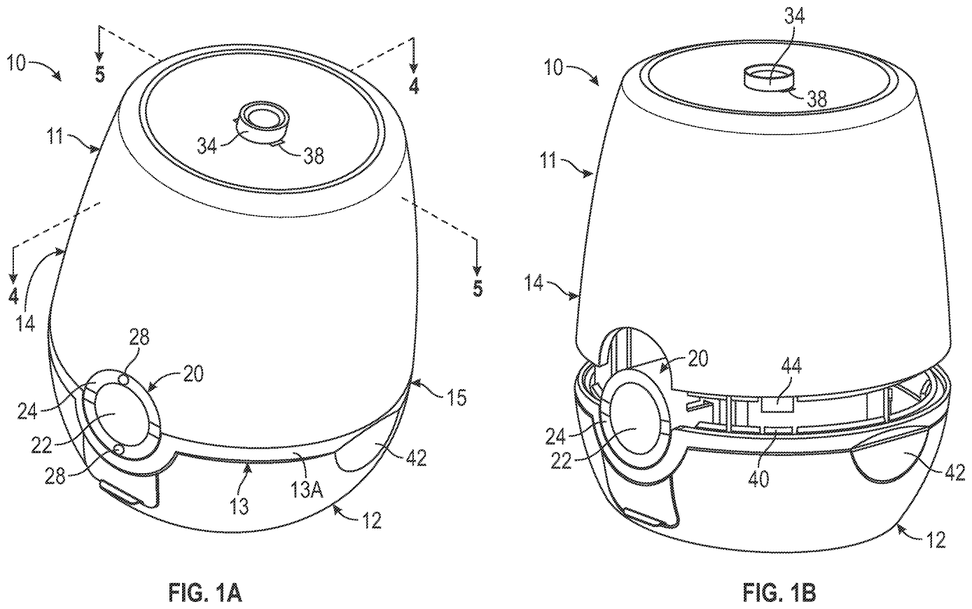

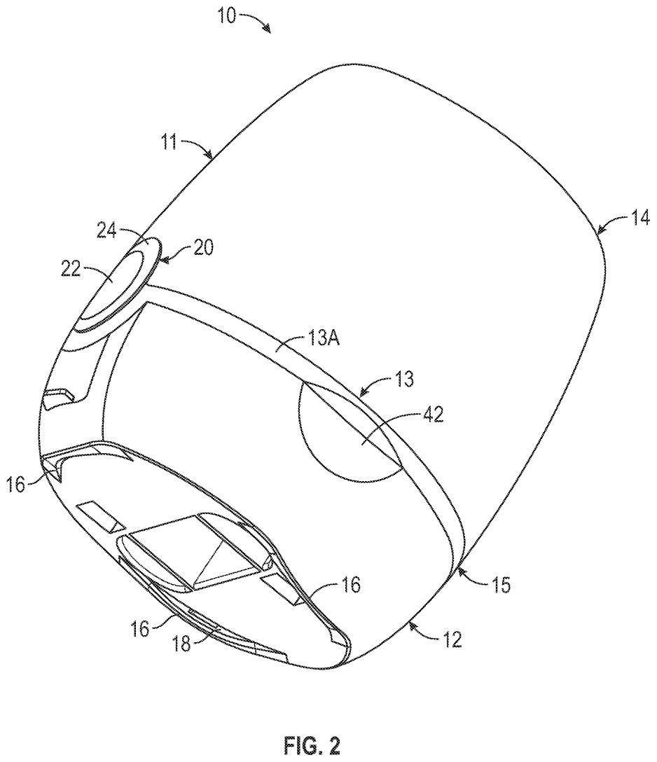

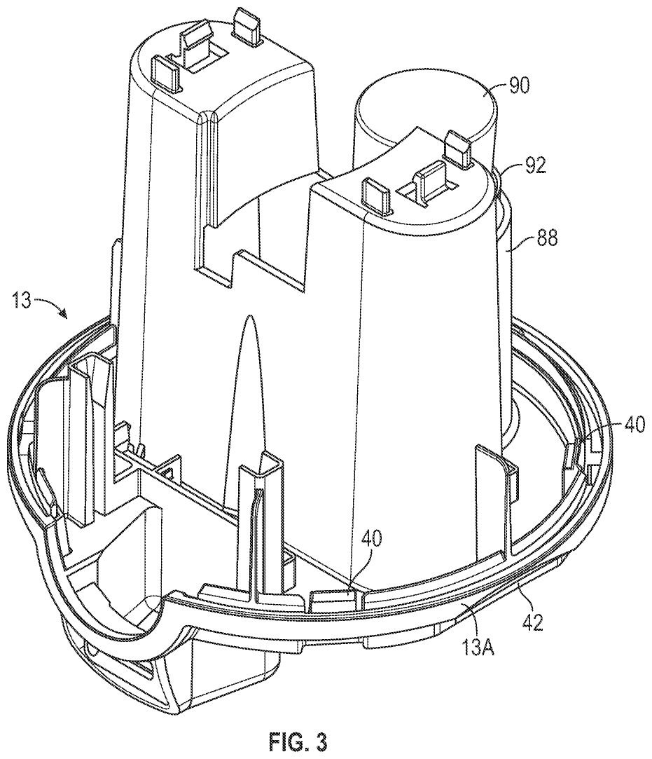

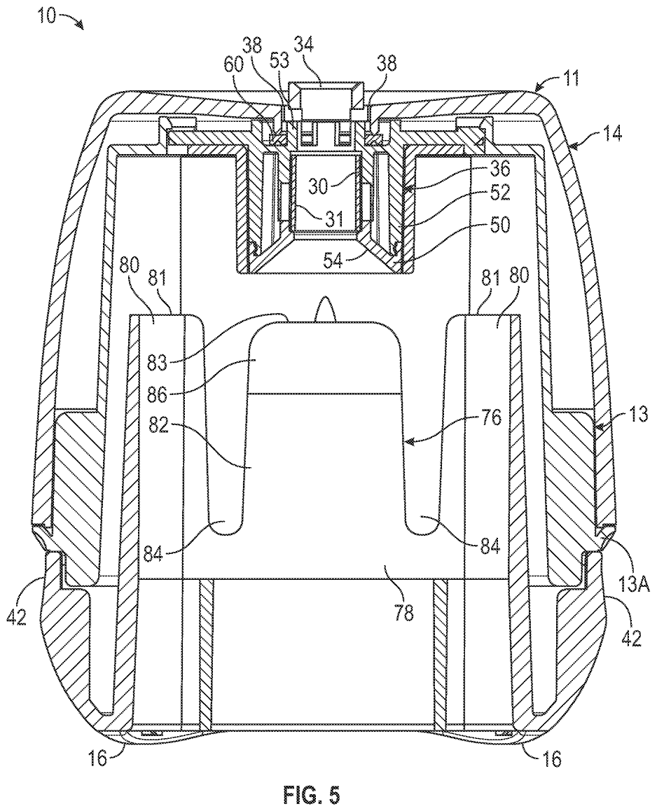

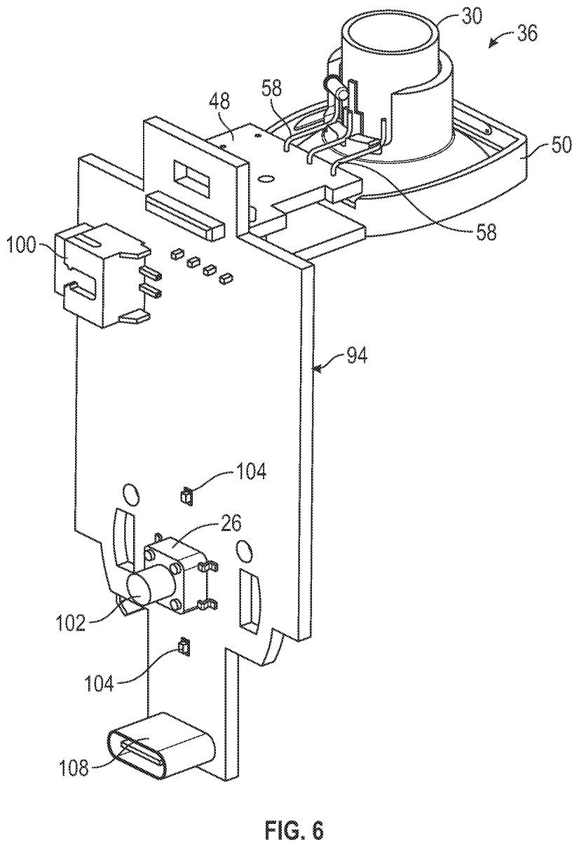

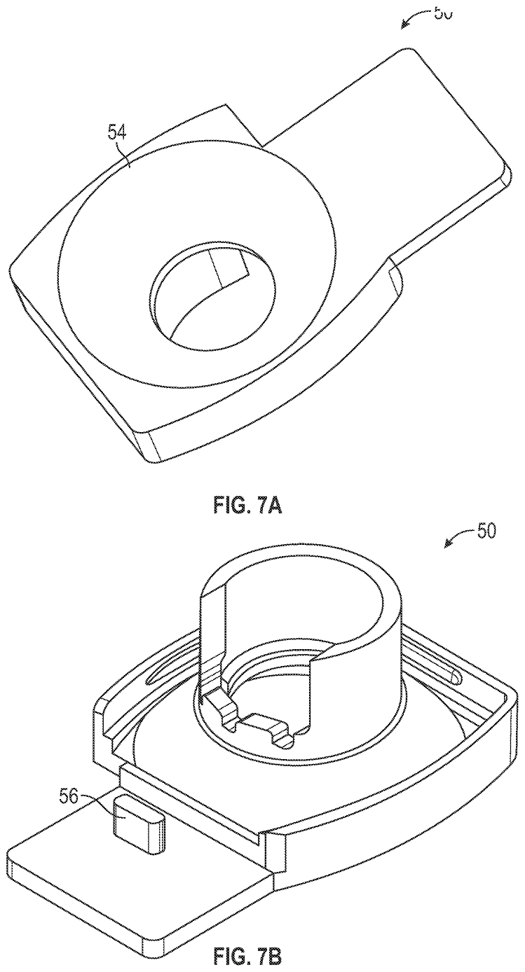

Referring now to the drawings, there is illustrated in FIGS. 1 through 11, a first embodiment of an insect repeller 10. The illustrated illuminated insect repeller 10 includes a repeller housing 11 having a base 12, a cover assembly 14, and an intermediate portion 13 between the base 12 and the cover assembly 14, wherein the intermediate portion 13 defines a beltline 13A. A lower surface of the base 12 includes a plurality of support feet 16, as best shown in FIG. 2. In the illustrated embodiment, the base 12 includes three support feet 16. However, it will be understood that the base 12 may have two or more support feet 16. In the illustrated embodiment, a lower surface of the base 12 also includes a drain opening 18 in at least one of the support feet 16, as also shown in FIG. 2. The drain openings 18 are configured to allow fluid, such as rainwater, to drain from the insect repeller 10. Each component of the repeller housing 11 may be formed from any desired rigid plastic material, including but not limited to polypropylene, glass filled polypropylene, polycarbonate, and blended polymers.

The cover assembly 14 further includes a user interface 20. The user interface 20 includes an on/off power button 22 mounted within an integrated display or status indicator lens 24 that includes optical identifier windows that signal various states of operation and potential fault situations. The on/off power button 22 is configured to engage an on/off power switch 26, described below. The optical identifier windows of the status indicator lens 24 are configured as selectively illuminated portions 28, shown as circles in FIG. 1A, and illuminated by corresponding light pipes 106, described below. The selectively illuminated portions 28 may be illuminated to indicate a plurality of operating and fault conditions. One of the selectively illuminated portions 28, for example the upper selectively illuminated portion 28 when viewing FIG. 1A, may be illuminated in a pulsing manner to indicate that a heater 30, described below in detail, is activated and heating. The upper selectively illuminated portion 28 may be illuminated in a blinking manner, such as with four fast blinks, to indicate that the base 12 or a fluid reservoir bottle 32, also described below in detail, is missing. The upper selectively illuminated portion 28 may also be illuminated in a steady-on manner to indicate that the heater 30 has reached a desire temperature.

Similarly, a second one of the selectively illuminated portions 28, for example the lower selectively illuminated portion 28 when viewing FIG. 1A, may be illuminated in a pulsing manner to indicate that the insect repeller 10 is charging. The lower selectively illuminated portion 28 may be illuminated in a blinking manner to indicate one or more of a low battery condition, that the insect repeller 10 is operating, and the that the insect repeller 10 in not plugged in. The lower selectively illuminated portion 28 may also be illuminated in a steady-on manner to indicate that the insect repeller 10 in plugged in and/or is fully charged.

The cover assembly 14 includes a centrally formed, generally cylindrical heater chimney 34 of a heater assembly 36. Additionally, one or more condensate drain holes 38 are formed through an upper surface of the cover assembly 14. In the illustrated embodiment, two condensate drain holes 38 are shown adjacent to the heater chimney 34. However, it will be understood that the cover assembly 14 may include any desired number of condensate drain holes 38.

The cover assembly 14 may be attached to the intermediate portion 13. For example, one of the cover assembly 14 or the intermediate portion 13 may include latching tabs that interface and lock with a mating striker boss on the other of the cover assembly 14 and the intermediate portion. In the illustrated embodiment, latching tabs 40 are formed on the intermediate portion 13, and corresponding striker bosses 44 are formed on the cover assembly 14. When attached together, the cover assembly 14 and the intermediate portion 13 define a housing subassembly 15. If desired, the beltline 13A may be illuminated.

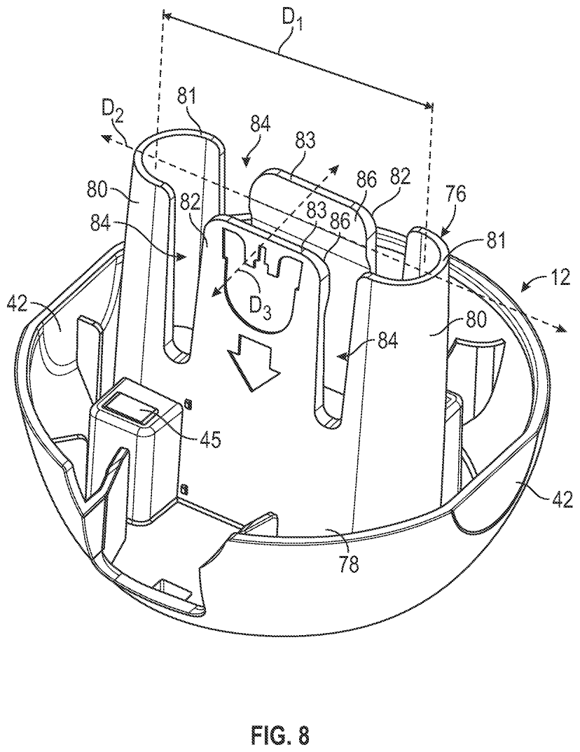

The housing subassembly 15 may be attached to the base 12 by a latch system including mating magnets and ferromagnetic contacts that retain the housing subassembly 15 and the base 12 together such that the assembled repeller housing 11 may be moved as a single structure. In the illustrated embodiment, as best shown in FIG. 8, the base 12 includes a plurality of magnets 45 configured to engage corresponding ferromagnetic contacts (not shown) in a lower surface of the intermediate portion 13. Additionally, thumb depressions 42 are formed in the base 12, and are configured to provide grab points for the insect repeller operator when separating the housing subassembly 15 from the base 12.

Alternatively, the housing subassembly 15 may be attached to the base 12 by a plurality of latching tabs that interface and lock with a corresponding plurality of mating striker bosses, such as described above. In such an embodiment, the thumb depressions 42 may be configured as detents formed in the base 12, such that squeezing the detents 42 by an operator unlatches the housing subassembly 15 from the base 12 so that they can be separated.

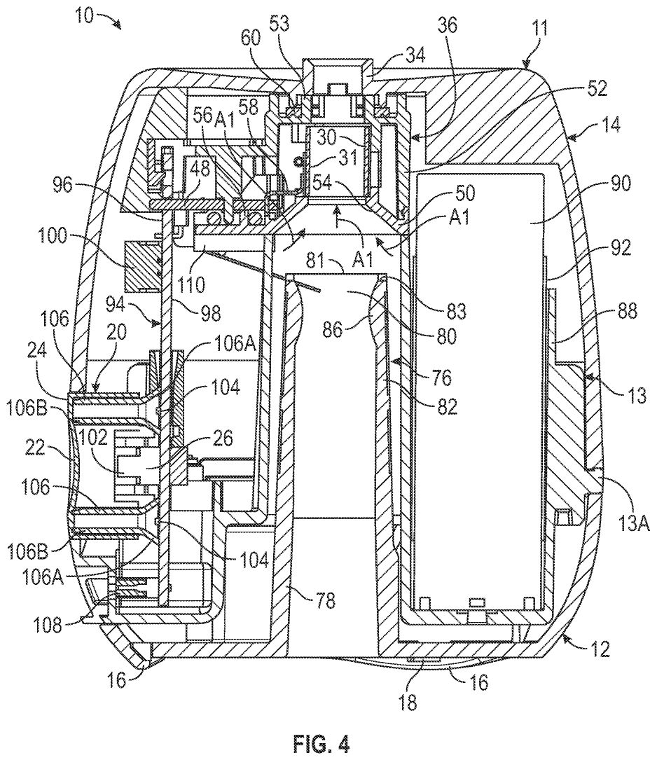

The heater assembly 36, best shown in FIGS. 4 through 6, includes a heater PCB 48 mounted between a first portion or heater base 50 and a second portion or heater housing 52, wherein the heater base 50 and the heater housing 52 are attached via a snap-fit connection. The illustrated heater base 50 includes a conical heater funnel 54.

The heater base 50 and the heater housing 52 are formed from any desired rigid, heat resistant plastic including, but not limited to, glass-filled nylon and other heat resistant plastic material. The heater base 50 includes a mounting boss 56 extending outwardly from an upper surface of the heater base 50 (upwardly when viewing FIG. 4). The mounting boss 56 is configured to engage the heater PCB 48. As best shown in Figs. and 10, the conical heater funnel 54 advantageously directs air within the insect repeller 10, as shown by the arrows A1, toward and into the heater 30.

The heater assembly 36 includes the generally cylindrical heater 30 that defines a heater bore 31 and is electrically connected to the heater PCB 48 via electrical connectors 58. A cylindrical, resilient heater seal 60 is mounted between the cover assembly 14 and the heater housing 52, and is positioned circumferentially around a cylindrical portion 53 of the heater housing 52 at a first end of the heater assembly 36 (the upper end when viewing FIG. 4). The heater 30 may be ceramic-based and configured as a negative temperature coefficient (NTC) or a positive temperature coefficient (PTC) thermistor controlled heater. Alternatively, other types of heaters may be used.

During assembly of the heater assembly 36, the heater 30 is electrically connected to the heater PCB 48 via the electrical connectors 58, and the heater PCB 48 and the cylindrical heater 30 are placed on the heater base 50. The heater housing 52 is then placed on to the heater base 50 and attached to the heater base 50 via a snap-fit connection. The heater seal 60 is then press fit circumferentially around the cylindrical portion 53 of the heater housing 52. The heater seal 60 may be formed from any desired flexible material, including but not limited to, rubber, and other desired heat resistant elastomers that are compatible with the liquid volatiles. The assembled heater assembly 36 may then be mounted within the cover assembly 14.

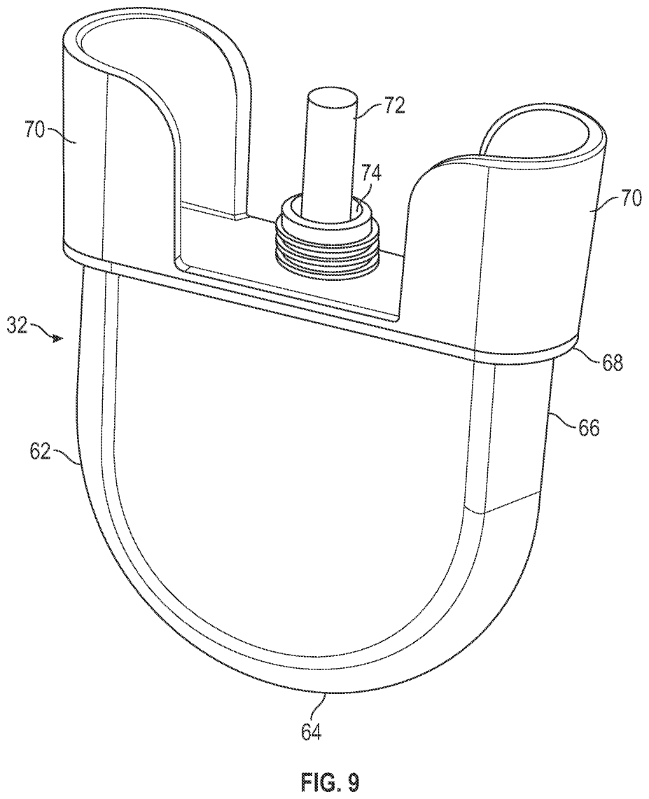

The fluid reservoir bottle 32 is shown in FIG. 9 and includes a reservoir 62. The reservoir 62 includes a rounded first or lower end 64, and a planar second or upper end 66 defining a flange 68. A pair wick guides 70 extends outwardly from the upper end 66 of the reservoir 62 (upwardly extending when viewing FIG. 9). The reservoir 62 may be filled with liquid insect repellent material and includes a wick 72 that extends into the interior of the reservoir 62 and outwardly through an opening 74 in the upper end 66 of the reservoir 62 between the pair of wick guides 70.

Referring now to FIGS. 4 and 8, a reservoir holder 76 is centrally formed in the base 12 and is configured to hold the fluid reservoir bottle 32. The reservoir holder 76 includes a holder base 78 integrally formed with the base 12 and opposing end walls 80 that have an arcuate cross-sectional shape and extend outwardly from the holder base 78 (upwardly when viewing FIG. 8). Distal end surfaces of the end walls 80 are perpendicular to longitudinal axes of the end walls 80 and define first bottle locating surfaces 81. Opposing side walls 82 also extend outwardly from the holder base 78 (upwardly when viewing FIG. 8) and are separated from the end walls 80 by grooves 84. Inwardly extending bottle gripping tabs 86 are formed at the distal ends of the side walls 82. Distal end surfaces of the side walls 82 are generally parallel with the first bottle locating surfaces 81 and define second bottle locating surfaces 83. The bottle gripping tabs 86 of the side walls 82 are resiliently deflected outwardly by the fluid reservoir bottle 32 when the fluid reservoir bottle 32 is inserted into the reservoir holder 76, thus applying a holding force on the fluid reservoir bottle 32 to retain the fluid reservoir bottle 32 in the reservoir holder 76 of the base 12.

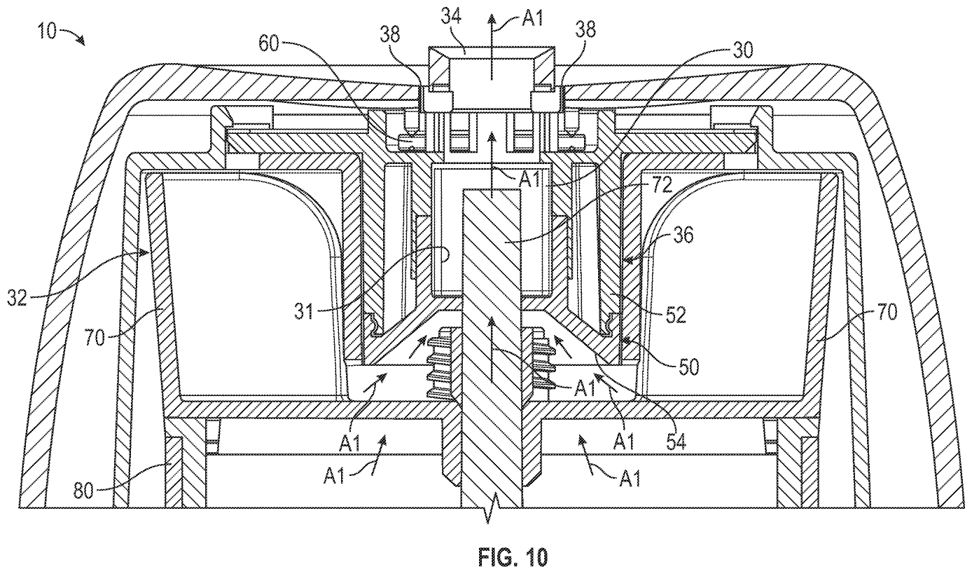

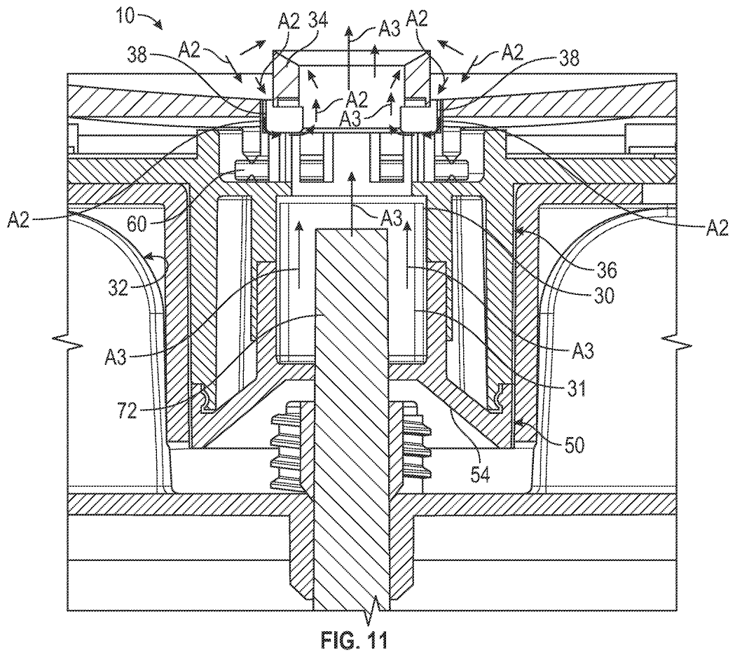

The reservoir holder 76 includes a first datum, indicated by the line D₁, that orients and secures the fluid reservoir bottle 32 in a first plane, i.e., a plane extending longitudinally within the reservoir holder 76 and through the line D₁ parallel with the opposing side walls 74. A second datum is a plane defined by the first bottle locating surfaces 81 and the line D₂, and assists in ensuring that the fluid reservoir bottle 32 is in a desired angular position relative to the first datum D₁. A third datum D₃ is a plane parallel with the second datum D₂, and is defined by the second bottle locating surfaces 83 and the line D₃, and further assists in ensuring that the fluid reservoir bottle 32 is in the desired angular position relative to the first datum D₁. As shown, the three datums D₁, D₂, and D₃ are configured so as to allow the operator to position the wick 72 of the fluid reservoir bottle 32 in a generally perpendicular orientation relative to a lower internal surface of the cover assembly 14, such that the wick 72 is positioned concentrically within the bore of the heater 30, as shown in FIGS. 10 and 11. This alignment prevents damage to the wick 72 when the cover assembly 14 is attached to the base 12.

When the fluid reservoir bottle 32 is seated within the reservoir holder 76, the wick 72 extends outwardly through the heater funnel 54 of the heater base 50 and into the heater 30. Liquid volatiles contained within the reservoir 62 are conducted by capillary action out of the reservoir 62 and to the distal end of the wick 72. The wick 72 is heated within the heater 30, causing the liquid volatiles to evaporate. This process continues until the reservoir 62 is empty.

The intermediate portion 13 includes a battery housing 88, configured to support a battery, such as for example, a rechargeable lithium-ion battery 90. Alternatively, the battery housing may be configured for two batteries, or other sources of electrical power. If desired, a conventional foam pad 92 may wrapped around the battery 90.

A device printed circuit board (PCB) 94 is mounted longitudinally within the repeller housing 11, includes an outboard facing first side 96 and a second side 98 opposite the first side 96, and is electrically connected to the battery 90. The first side 96 of the device PCB 94 may include a microcontroller 100, other required functional electronic components, and the on/off power switch 26 having an outwardly extending post 102 electrically mounted to the device PCB 94 and necessary to operate the insect repeller 10. Illumination light sources, such as LEDs 104 are also provided on the device PCB 94 for illuminating the selectively illuminated portions 28 of the status indicator lens 24. Light pipes 106 extend between the LEDs 104 on the device PCB 94 and an interior, or back side, of the selectively illuminated portions 28 of the status indicator lens 24 and direct light from the LEDs 104 to the status indicator lens 24.

To operate the insect repeller 10, an operator presses the on/off power button 22 into contact with the on/off power switch 26. A first end 106A of each light pipe 106 is flared or funnel shaped and abuts the device PCB 94 about the LED 104 and a second end 106B of each light pipe 106 abuts the status indicator lens 24. Advantageously, the flared light pipes 106 are resilient and act as a return spring to reposition the on/off power button 22 after the operator has pressed the on/off power button 22. The light pipes 106 also provides a tactile effect or resistance when the operator presses the on/off power button 22, and prevents rattling of the on/off power button 22.

A charging port, such as a USB-C connector port 108, is also mounted to the PCB 94. In the illustrated embodiment, the USB-C connector port 108 is mounted below and adjacent to the user interface 20. In addition to re-charging the battery 90, the connector port 108 may connect the insect repeller 10 to an electrical power source, such as a fixed base electrical source found in buildings and homes (typically 110/120 volts in the U.S. for example) or an environmental-generated power source such as a solar panel or wind turbine, or have a battery power source.

The insect repeller 10 may also include a bottle sensing switch 110, best shown in FIG. 4. The bottle sensing switch 110 is actuated when a fluid reservoir bottle 32 is properly installed within the insect repeller 10, thus preventing operation of the insect repeller 10 when a fluid reservoir bottle 32 is not installed. The bottle sensing switch 110 is movable between an actuated position wherein the insect repeller 10 is operational and an unactuated position, wherein the insect repeller 10 is prevented from operating. The bottle sensing switch 110 is moved to the actuated position when the reservoir bottle 32 is properly installed within the insect repeller 10, and the bottle sensing switch 110 is moved to the unactuated position when the reservoir bottle 32 is removed or not installed, thus preventing operation of the insect repeller 10 when the reservoir bottle 32 is not installed. By preventing the insect repeller 10 from operating without a properly installed fluid reservoir bottle 32, the heater assembly 36 is prevented from heating, thus preventing unintended access to an operating heater assembly 36 and preventing accidental operator contact with a hot heater assembly 36, such as by the operator's fingers from the underside of the cover assembly 14.

Advantageously, the insect repeller 10 is structured such that the fluid reservoir bottle 32 is installed and held in the base 12, and all the electronic components are mounted in the housing subassembly 15, defined as the cover assembly 14 and the intermediate portion 13 when attached together, as described above.

As best shown in FIGS. 1A, 1B, 5, and 11, the insect repeller 10 includes at least one of the condensate drain holes 38. In the illustrated embodiment, the upwardly facing surface of the cover assembly 14 is concave. During operation of the insect repeller 10, the liquid volatiles carried by the wick 72 are heated by the heater 30, and caused to evaporate and flow outwardly through the chimney 34, as shown by the arrows A3 in FIG. 11. A portion of the vaporized volatiles may condense upon exiting the chimney 34 due to environmental conditions, and collect as condensate on the concave, upwardly facing surface of the cover assembly 14. The condensate drain holes 38, two of which are formed in the illustrated embodiment of the insect repeller 10, allow the collected condensate to flow through the condensate drain holes 38 and into the insect repeller 10. Thus, the reclaimed condensate may be reheated and evaporated with the outward flow of evaporated volatiles, as shown in FIG. 11.

Additionally, the condensate drain holes 38 are configured and positioned to pull air, as shown by the arrows A2, from the environment through the condensate drain hole 38 while the insect repeller 10 is operating, which further promotes reclamation of the condensate as the air, shown by the arrows A2 mixes with the heated air, shown by the arrows A3.

Although not illustrated, a plurality of the insect repellers 10 may be linked together via a hub controller (not shown) to define a linked insect repeller system. Such a linked insect repeller system may be connected in series, in parallel, or combinations thereof.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An insect repeller comprising:
a repeller housing defining a reservoir holder therein, and having a chimney centrally formed on an upper end thereof; and
a heater assembly disposed within the repeller housing assembly, the heater assembly including a heater base attached to an underside of a heater housing, the heater housing having a cylindrical heater defining a heater bore, wherein the heater bore is in fluid communication with the chimney, wherein the heater is electrically connected to a source of electrical power, and wherein the heater base includes a conical heater funnel.

2. The insect repeller according to claim 1, further including:
a reservoir bottle disposed in the reservoir holder, the reservoir bottle including a reservoir configured to hold liquid insect repellant material therein and including a wick that extends into an interior of the reservoir and outwardly through an opening in a closed upper end of the reservoir, wherein liquid insect repellant material contained within the reservoir is conducted by capillary action out of the reservoir and to a distal end of the wick;
wherein the wick of the reservoir bottle extends longitudinally through the conical heater funnel of the heater base and into the heater bore of the cylindrical heater; and
wherein heat from the cylindrical heater vaporizes liquid insect repellent within the wick, such that the vaporized insect repellant flows outwardly through the chimney.

3. The insect repeller according to claim 2, wherein the repeller housing further includes a base, a cover assembly, and an intermediate portion between the base and the cover assembly and defining a beltline.

4. The insect repeller according to claim 3, wherein the beltline is illuminated.

5. The insect repeller according to claim 3, wherein when the cover assembly and the intermediate portion are attached together, they define a housing subassembly.

6. The insect repeller according to claim 3, wherein the repeller housing is configured such that the reservoir bottle is removably mounted in the base, and electronic components of the insect repeller are mounted in the housing subassembly.

7. The insect repeller according to claim 3, wherein a lower surface of the base includes a plurality of support feet and a drain opening configured to allow fluid to drain from the insect repeller.

8. The insect repeller according to claim 3, wherein the chimney is a cylindrical heater chimney centrally formed in an upwardly facing surface of the cover assembly, and wherein at least one condensate drain hole is formed through the upper surface of the cover assembly, the at least one condensate drain hole configured to allow condensate collected on the upper surface of the cover assembly to flow through the at least one condensate drain hole and into the insect repeller, thus allowing the reclaimed condensate to be reheated with the outward flow of vaporized repellant.

9. The insect repeller according to claim 8, wherein the upwardly facing surface of the cover assembly is concave.

10. The insect repeller according to claim 2, wherein the reservoir includes a rounded first end, a planar second end defining a flange, and a pair wick guides extending outwardly from the second end of the reservoir, and wherein the wick extends from the interior of the reservoir and outwardly through an opening in the second end of the reservoir between the pair of wick guides.

11. The insect repeller according to claim 3, wherein the reservoir holder is centrally formed in the base and is configured to hold the reservoir bottle, the reservoir holder including:
a holder base integrally formed with the base having opposing end walls and opposing side walls;
wherein the opposing end walls have an arcuate cross-sectional shape and extend outwardly from the holder base;
wherein distal end surfaces of the end walls are perpendicular with longitudinal axes of the end walls and define first bottle locating surfaces;
wherein the opposing side walls extend outwardly from the holder base and are separated from the end walls by grooves;
wherein inwardly extending bottle gripping tabs are formed at the distal ends of the side walls;
wherein distal end surfaces of the side walls are parallel with the first bottle locating surfaces and define second bottle locating surfaces; and
wherein the bottle gripping tabs are resiliently deflected by the reservoir bottle when the reservoir bottle is inserted into the reservoir holder, thus applying a holding force on the reservoir bottle to retain the reservoir bottle in the reservoir holder.

12. The insect repeller according to claim 5, further including:
a device PCB mounted within the housing subassembly and having a microcontroller and electronic components;
a battery electrically connected to the PCB; and
a bottle sensing switch mounted within the subassembly;
wherein the bottle sensing switch is movable between an actuated position wherein the insect repeller is operational and an unactuated position wherein the insect repeller is prevented from operating;
wherein the bottle sensing switch is moved to the actuated position when the reservoir bottle is properly installed within the insect repeller; and
wherein the bottle sensing switch is moved to the unactuated position when the reservoir bottle is not installed, thus preventing operation of the insect repeller when the reservoir bottle is not installed.

13. The insect repeller according to claim 5, further including:
a user interface mounted in the cover assembly, the user interface having an on/off power button mounted within an integrated status indicator lens, wherein the status indicator lens includes optical identifier windows that signal states of operation and potential fault situations;
a device PCB mounted within the housing subassembly and having a microcontroller, an on/off power switch, and LEDs;
a battery electrically connected to the PCB; and
a plurality of light pipes that extend between the LEDs on the device PCB and an interior side of the optical identifier windows of the status indicator lens and direct light from the LEDs to the status indicator lens;
wherein a first end of each light pipe is flared and abuts the device PCB about one of the LEDs and a second end of each light pipe abuts the status indicator lens; and
wherein the flared light pipes are resilient and are configured to act as a return spring to reposition the on/off power button after an insect repeller operator has pressed the on/off power button to engage the on/off power switch.

14. An insect repeller comprising:
a repeller housing defining a reservoir holder therein, and having a chimney centrally formed on an upper end thereof, the repeller housing including a base, a cover assembly, and an intermediate portion between the base and the cover assembly and defining a beltline, wherein when the cover assembly and the intermediate portion are attached together they define a housing subassembly;
a user interface mounted in the cover assembly, the user interface having an on/off power button mounted within an integrated status indicator lens, wherein the status indicator lens includes optical identifier windows that signal states of operation and potential fault situations;
a device PCB mounted within the housing subassembly and having a microcontroller, an on/off power switch, and LEDs;
a battery electrically connected to the PCB; and
a plurality of light pipes that extend between the LEDs on the device PCB and an interior side of the optical identifier windows of the status indicator lens and direct light from the LEDs to the status indicator lens;
wherein a first end of each light pipe is flared and abuts the device PCB about one of the LEDs and a second end of each light pipe abuts the status indicator lens; and
wherein the flared light pipes are resilient and are configured to act as a return spring to reposition the on/off power button after an insect repeller operator has pressed the on/off power button to engage the on/off power switch.

15. The insect repeller according to claim 14, further including:
a reservoir bottle disposed in the reservoir holder, the reservoir bottle including a reservoir configured to hold liquid insect repellant material therein and including a wick that extends into an interior of the reservoir and outwardly through an opening in a closed upper end of the reservoir, wherein the liquid insect repellent material contained within the reservoir is conducted by capillary action out of the reservoir and to a distal end of the wick; and
a heater assembly disposed within the repeller housing assembly, the heater assembly including a heater base attached to an underside of a heater housing, the heater housing having a cylindrical heater defining a heater bore, wherein the heater bore is in fluid communication with the chimney, and wherein the heater is electrically connected to a source of electrical power;
wherein the wick of the reservoir bottle extends longitudinally through the heater base and into the heater bore of the cylindrical heater; and
wherein heat from the cylindrical heater vaporizes liquid repellent within the wick, such that the vaporized repellant flows outwardly through the chimney.

16. The insect repeller according to claim 15, wherein a lower surface of the base includes a plurality of support feet and a drain opening configured to allow fluid to drain from the insect repeller.

17. The insect repeller according to claim 15, wherein the chimney is a cylindrical heater chimney centrally formed in an upwardly facing surface of the cover assembly, and wherein at least one condensate drain hole is formed through the upper surface of the cover assembly, the at least one condensate drain hole configured to allow condensate collected on the upper surface of the cover assembly to flow through the at least one condensate drain hole and into the insect repeller, thus allowing the reclaimed condensate to be reheated with the outward flow of vaporized repellant.

18. The insect repeller according to claim 15, wherein the reservoir holder is centrally formed in the base and is configured to hold the reservoir bottle, the reservoir holder including:
a holder base integrally formed with the base having opposing end walls and opposing side walls;
wherein the opposing end walls have an arcuate cross-sectional shape and extend outwardly from the holder base;
wherein distal end surfaces of the end walls are perpendicular with longitudinal axes of the end walls and define first bottle locating surfaces;
wherein the opposing side walls extend outwardly from the holder base and are separated from the end walls by grooves;
wherein inwardly extending bottle gripping tabs are formed at the distal ends of the side walls;
wherein distal end surfaces of the side walls are parallel with the first bottle locating surfaces and define second bottle locating surfaces; and
wherein the bottle gripping tabs are resiliently deflected by the reservoir bottle when the reservoir bottle is inserted into the reservoir holder, thus applying a holding force on the reservoir bottle to retain the reservoir bottle in the reservoir holder.

19. An insect repeller comprising:
a repeller housing defining a reservoir holder therein, and having a chimney centrally formed on an upper end thereof, the repeller housing including a base, a cover assembly, and an intermediate portion between the base and the cover assembly and defining a beltline, wherein when the cover assembly and the intermediate portion are attached together they define a housing subassembly;
a device PCB mounted within the housing subassembly and having a microcontroller and electronic components;
a battery electrically connected to the PCB; and
a bottle sensing switch mounted within the subassembly;
wherein the bottle sensing switch is movable between an actuated position wherein the insect repeller is operational and an unactuated position wherein the insect repeller is prevented from operating;
wherein the bottle sensing switch is moved to the actuated position when the reservoir bottle is properly installed within the insect repeller; and
wherein the bottle sensing switch is moved to the unactuated position when the reservoir bottle is not installed, thus preventing operation of the insect repeller when the reservoir bottle is not installed.

20. The insect repeller according to claim 19, further including:
a reservoir bottle disposed in the reservoir holder, the reservoir bottle including a reservoir configured to hold liquid insect repellant material therein and including a wick that extends into an interior of the reservoir and outwardly through an opening in a closed upper end of the reservoir, wherein the liquid insect repellent material contained within the reservoir is conducted by capillary action out of the reservoir and to a distal end of the wick; and
a heater assembly disposed within the repeller housing assembly, the heater assembly including a heater base attached to an underside of a heater housing, the heater housing having a cylindrical heater defining a heater bore, wherein the heater bore is in fluid communication with the chimney, and wherein the heater is electrically connected to a source of electrical power;
wherein the wick of the reservoir bottle extends longitudinally through the heater base and into the heater bore of the cylindrical heater; and
wherein heat from the cylindrical heater vaporizes liquid repellent within the wick, such that the vaporized repellant flows outwardly through the chimney.

21. The insect repeller according to claim 20, wherein a lower surface of the base includes a plurality of support feet and a drain opening configured to allow fluid to drain from the insect repeller.

22. The insect repeller according to claim 20, wherein the chimney is a cylindrical heater chimney centrally formed in an upwardly facing surface of the cover assembly, and wherein at least one condensate drain hole is formed through the upper surface of the cover assembly, the at least one condensate drain hole configured to allow condensate collected on the upper surface of the cover assembly to flow through the at least one condensate drain hole and into the insect repeller, thus allowing the reclaimed condensate to be reheated with the outward flow of vaporized repellant.

23. The insect repeller according to claim 20, wherein the reservoir holder is centrally formed in the base and is configured to hold the reservoir bottle, the reservoir holder including:
a holder base integrally formed with the base having opposing end walls and opposing side walls;
wherein the opposing end walls have an arcuate cross-sectional shape and extend outwardly from the holder base;
wherein distal end surfaces of the end walls are perpendicular with longitudinal axes of the end walls and define first bottle locating surfaces;
wherein the opposing side walls extend outwardly from the holder base and are separated from the end walls by grooves;
wherein inwardly extending bottle gripping tabs are formed at the distal ends of the side walls;
wherein distal end surfaces of the side walls are parallel with the first bottle locating surfaces and define second bottle locating surfaces; and
wherein the bottle gripping tabs are resiliently deflected by the reservoir bottle when the reservoir bottle is inserted into the reservoir holder, thus applying a holding force on the reservoir bottle to retain the reservoir bottle in the reservoir holder.
